(19) United States
(12) Patent Application Publication
(10) Pub. No.: US 2026/0249812 A1
(43) Pub. Date: Aug. 27, 2026

(54) METHOD FOR ACTIVATING AT LEAST ONE FUNCTION OF A MOTOR VEHICLE FROM A DEVICE CARRIED BY A USER OF SAID VEHICLE

(71) Applicant: Continental Automotive Technologies GmbH, Hannover (DE)

(72) Inventors: Mohamed CHEIKH, L'Union (FR); Benjamin DUBOIS, Bailleau-l'Evêque (FR)

(73) Assignee: Continental Automotive Technologies GmbH, Hannover (DE)

(21) Appl. No.: 19/160,245

(22) PCT Filed: Mar. 15, 2024
(86) PCT No.: PCT/EP2024/057017

§ 371 Date: Aug. 27, 2025

(30) Foreign Application Priority Data
Mar. 20, 2023 (FR) FR2302579

(51) Int. Cl. B60R 25/24; G07C 9/00; H04W 4/02; H04W 4/40; H04W 4/80

(52) U.S. Cl. CPC B60R 25/245; G07C 9/00309; H04W 4/027; H04W 4/40; H04W 4/80; G07C 2209/63

(57) ABSTRACT

A method for activating at least one function of a vehicle from an equipment carried by a user of the vehicle, including the steps of: receiving, by the user equipment, the geolocation of the vehicle; determining the geolocation of the user equipment; comparing, by the processor, the geolocation of the user equipment in order to determine the path of the user; determining, by the processor, a movement factor; determining, by the processor, the distance of the user equipment from the vehicle; computing, by the processor, a user intent Int; and sending to the activation system via the antenna module a signal for activating the location function performed by the UWB antenna module when the computed user intent Int is greater than a first predetermined threshold.

### CROSS REFERENCE TO RELATED APPLICATIONS

This application is the U.S. National Phase Application of PCT International Application No. PCT/EP2024/057017, filed Mar. 15, 2024, which claims priority to French Patent Application No. FR2302579, filed Mar. 20, 2023, the contents of such applications being incorporated by reference herein.

### FIELD OF THE INVENTION

The invention relates to the automotive field and more particularly relates to a method for activating at least one function of a motor vehicle from an equipment carried by a user of said vehicle and to a user equipment implementing said method.

### BACKGROUND OF THE INVENTION

In a motor vehicle, it is known to equip a vehicle with a so-called “hands-free” activation system allowing a user to lock or unlock the doors of his or her vehicle from an equipment carried by said user without the need to press a button (N.B. the term “doors” is understood here to encompass the passenger-compartment doors, the lid of the trunk, the lid of the frunk where appropriate and potentially even the hood). In a known manner, the equipment for example takes the form of a keycard, of a remote control, of a key or of a smartphone.

As shown in FIG. 1, when the user 2A approaches the vehicle 1A and enters into a region of coverage 15 defined around the vehicle 1A, the user equipment detects a signal transmitted periodically by the activation system 11A on a BLE communication interface (BLE standing for Bluetooth® Low Energy).

The activation system 11A communicates in return with the BLE communication equipment over a communication link, also of BLE type, in order to authenticate it.

Authentication on the BLE communication interface triggers, in the user equipment, activation of a location function intended to locate said equipment via a UWB interface (UWB standing for Ultra Wide Band).

The activation system 11A and the user equipment communicate over a UWB communication link in order to allow the system to locate the equipment using the strength of the signals transmitted by said equipment.

Next, when the system determines that the user equipment 2A is located in a region said to be “of activation” 16, the activation system 11A unlocks the doors. The region of activation corresponds to a second region defined around the vehicle, of smaller area than the region of coverage 15—it for example corresponds to the region less than 1.3 meters from the vehicle 1A.

Similarly, when the user 2A moves away from the vehicle 1A, the activation system 11A and the user equipment communicate over a UWB communication link in order to allow the system to locate the equipment using the strength of the signals transmitted by said equipment.

With so-called UWB locking, for example at more than 2 meters from the vehicle, the system then locks the doors.

One drawback of this method resides in the attempts made by the UWB system to constantly locate the user equipment via UWB once the equipment has been detected in the region of coverage.

Specifically, the constant attempts at location by the location function increases consumption of power from the battery of the vehicle. The impact of this increases when the user remains in the region of coverage without entering into the unlocking region. This may in particular occur when the vehicle is parked in a garage adjacent to a house with the user equipment located in the region of coverage but outside the unlocking region, or when the user is seated in proximity to the vehicle, for example on a terrace, with the equipment located in the region of coverage but outside the unlocking region.

In addition, detection of the equipment in the region of coverage leads to activation of all of the UWB antennas of the vehicle, with a view to more accurately locating the equipment, this further increasing power consumption.

Moreover, according to CCC standard (CCC standing for Car Connectivity Consortium) the UWB communication interface is deactivated after two minutes of connection to the BLE interface if the user equipment is not detected in the region of activation 16.

In other words, if the user stops for more than two minutes when approaching the vehicle, the UWB communication interface is deactivated, and if the user then begins to approach once more she or he will no longer be able to unlock the vehicle. Here, this effect is called the “timeout effect”.

Therefore, there is a need for a solution allowing these drawbacks to be at least partly overcome.

### SUMMARY OF THE INVENTION

To this end, a first subject of the invention is a method for activating at least one function of a vehicle from an equipment carried by a user of said vehicle, said user equipment comprising a processor, an array of position and movement sensors and an antenna module configured to communicate via UWB and BLE with the vehicle, the vehicle comprising a so-called “hands-free” activation system configured to implement a UWB location function, said activation system comprising an electronic control unit, at least one UWB antenna module, connected to said electronic control unit and configured to communicate via UWB with the user equipment in a region of activation around the vehicle, and at least one BLE antenna module, connected to said electronic control unit and configured to communicate via BLE in a region of coverage around the vehicle, said electronic control unit being configured to receive the geolocation of the vehicle and a value of an angle of orientation of the vehicle with respect to magnetic north, said method being triggered by detection of presence of the user equipment in the region of coverage around the vehicle and comprising the steps, implemented by the user equipment, of:
receiving, via the BLE antenna module, the geolocation of the vehicle sent by said vehicle,
determining, via the array of position and movement sensors, the geolocation of the user equipment,
comparing, by means of the processor, the determined geolocation of the user equipment with a history of previously recorded geolocations of the user equipment in order to determine the path of the user,
determining, by means of the processor, a movement factor, denoted o, equal to 0 if the user is determined to not be moving and equal to 1 if the user is determined to be moving,
determining, by means of the processor, the distance of the user equipment from the vehicle based on the received geolocation of the vehicle and on the determined geolocation of the user equipment,
computing, by means of the processor, a user intent Int, according to the following formula:

[Math 1]

$$Int = σ [ 1 - ( α \vert d \vert ) ]$$

where σ is the movement factor, α is a calibration factor, and |d| is the determined distance between the user equipment and the vehicle divided by a maximum reference distance,
sending, via the antenna module, to the activation system of the vehicle, a signal for activating the UWB location function when the computed user intent Int is greater than a first predetermined threshold or deactivating the location function performed by means of the UWB antenna module when the computed user intent Int is less than a second predetermined threshold.

This method saves energy by activating the UWB communication between the vehicle and the user equipment only when the user intent Int is high enough, i.e. when the user is moving and close enough to the vehicle. This in particular makes it possible to avoid triggering UWB functions when the vehicle is parked in a garage adjacent to the house in which the user lives.

Preferably, the determined distance between the user equipment and the vehicle is divided by a maximum reference distance so that the user intent Int is less than or equal to 1. For example, the maximum reference distance may be set to 100 m.

Likewise, in a case where the user exits the vehicle and moves away from it, the UWB communication is stopped below a certain threshold of user intent Int, before the communication between the user and the vehicle via BLE is stopped.

Advantageously, the user equipment is configured to determine, based on successive positions of the user and on the angle of orientation of the vehicle with respect to magnetic north, the angle θ made by the direction of the path of the user equipment to the straight line connecting the user equipment and the vehicle. The user equipment may therefore perform additional measurements of the path of the user.

Also advantageously, the user intent, denoted Int, is computed using the formula:

[Math 2]

$$Int = σ [ 1 - [ ( α \cdot \vert d \vert ) + β \cdot sin θ ] ]$$

where σ is the movement factor, α and β are calibration factors, |d| is the determined distance between the user equipment and the vehicle divided by a maximum reference distance and θ is the angle made by the direction of the path of the user equipment to the straight line connecting the user equipment and the vehicle. This formula allows the direction of the user to be taken into account in the computation of the user intent Int. If the user is in the region of coverage but the angle is large, the user is not moving directly toward the vehicle and the user intent Int will be lower. In contrast, if he or she is moving in a straight line toward the vehicle, the user intent Int is higher. The determined distance between the user equipment and the vehicle is divided by a maximum reference distance so that the user intent Int is less than or equal to 1. For example, the maximum reference distance may be set to 100 m.

Preferably, the user equipment is configured to determine, based on successive positions of the user, a value of an instantaneous speed of the user and to compute the user intent Int according to the formula:

[Math 3]

$$Int = σ [ 1 - [ ( α \cdot \vert d \vert ) + β \cdot sin θ + γ \cdot \vert V \vert \cdot cos θ ] ]$$

where σ is the movement factor, α, β and γ are calibration factors, |d| is the determined distance between the user equipment and the vehicle 1 divided by a maximum reference distance, θ is the angle made by the direction of the path of the user equipment to the straight line connecting the user equipment and the vehicle and |V| is the value of the instantaneous speed of the user divided by a maximum reference speed. This formula allows the speed of the user to be taken into account in the computation of the user intent Int. If the user is in the region of coverage but his or her speed is low, the user intent Int will be lower. In contrast, if he or she has a high speed in this region, the user intent Int is higher. The determined distance between the user equipment and the vehicle and the value of the instantaneous speed of the user are divided by a maximum reference distance and a maximum reference speed, respectively, so that the user intent Int is less than or equal to 1. For example, the maximum reference distance may be set to 100 m and the maximum reference speed may be set to 2 m/s.

Advantageously, the movement factor o is computed based on successive measurements of the absolute amplitude of an acceleration by the array of position and movement sensors over a predefined time interval. The factor o makes it possible to determine whether the user is moving or stationary, and the acceleration is preferably measured by an accelerometer. As long as this factor is equal to 0, the user is considered to be stationary and to have no intention to approach. Computing the factor o with a plurality of successive measurements makes it possible to differentiate between a temporary stop of the user on his or her approach path and a longer stop, for example in a dwelling next to which the vehicle is parked.

Preferably, the method defines a plurality of thresholds for the value of the user intent Int, crossing of said thresholds triggering a modification of the frequency at which UWB signals are sent by the vehicle. The more accurate UWB detection thus starts gradually and allows the user to be more accurately located in a larger area while continuing to save energy. In the case where the user moves away from the vehicle, the decrease in the frequency makes it possible to avoid having to suddenly reactivate the UWB communication should the user turn around.

In one variant, the method comprises a step of computing an intent to move away, denoted IntE, of a user of a vehicle, computed based on the user intent Int computed as previously indicated, according to the following formula:

[Math 4]

$$IntE = 1 - Int$$

In this particular case, the intent to move away IntE may be computed when the user moves away from the vehicle, and the UWB communication may be deactivated when the intent to move away IntE exceeds a certain threshold.

An aspect of the invention also relates to a method implemented by a user equipment, comprising an array of position and movement sensors, and by a vehicle, comprising a UWB antenna module configured to transmit and receive UWB signals, said method comprising the steps of:
determining, by means of said vehicle, the geolocation of said vehicle,
sending, by means of the vehicle, said geolocation via the UWB antenna module,
receiving, by means of said user equipment, said sent geolocation,
determining, via the array of position and movement sensors of the user equipment, the geolocation of said user equipment,
comparing the geolocation of the user equipment with a history of previously recorded geolocations of the user equipment in order to determine the path of the user,
determining a movement factor, denoted o, equal to 0 if the user is determined to not be moving and equal to 1 if the user is determined to be moving,
determining the distance of the user equipment from the vehicle based on the received geolocation of the vehicle and on the determined geolocation of the user equipment,
computing a user intent Int,
generating a signal for activating the location function when the computed user intent Int is greater than a first predetermined threshold or deactivating the location function performed by means of the UWB antenna module when the computed user intent Int is less than a second predetermined threshold,
triggering the access function by means of the activation system of the vehicle when the UWB location function detects the user in the region of activation around the vehicle.

An aspect of the invention also relates to a user equipment comprising a processor and an array of position and movement sensors and an antenna module configured to communicate via UWB and BLE with the vehicle, configured to receive the geolocation of the vehicle transmitted by the BLE antenna module, determine the geolocation of the user equipment by means of the array of position and movement sensors, compare the geolocation of the user equipment with a history of previously recorded geolocations of the user equipment in order to determine the path of the user, determine a movement factor, denoted o, equal to 0 if the user is determined to not be moving and equal to 1 if the user is determined to be moving, determine the distance of the user equipment from the vehicle based on the received geolocation of the vehicle and on the determined geolocation of the user equipment, compute a user intent Int by means of the formula:

[Math 5]

$$Int = σ [ 1 - [ ( α \cdot \vert d \vert ) ] ]$$

where σ is the movement factor, a is a calibration factor, |d| is the determined distance between the user equipment and the vehicle divided by a maximum reference distance, and send to the activation system, by means of the antenna module, a signal for activating the location function performed by means of the UWB antenna module when the computed user intent Int is greater than a first predetermined threshold or deactivating the location function performed by means of the UWB antenna module when the computed user intent Int is less than a second predetermined threshold.

Preferably, the user equipment is configured to determine, based on successive positions of the user and on the angle of orientation of the vehicle with respect to magnetic north, the angle θ made by the direction of the path of the user equipment to the straight line connecting the user equipment and the vehicle. As a variant, the user equipment computes the user intent denoted Int by means of the formula:

[Math 6]

$$Int = σ [ 1 - [ ( α \cdot \vert d \vert ) + β \cdot sin θ ] ]$$

where σ is the movement factor, α and β are calibration factors, |d| is the determined distance between the user equipment and the vehicle divided by a maximum reference distance and θ is the angle made by the direction of the path of the user equipment to the straight line connecting the user equipment and the vehicle.

Also preferably, the user equipment is configured to determine, based on successive positions of the user, a value of an instantaneous speed of the user and to compute the user intent Int according to the formula:

[Math 7]

$$Int = σ [ 1 - [ ( α \cdot \vert d \vert ) + β \cdot sin θ + γ \cdot \vert V \vert \cdot cos θ ] ]$$

where σ is the movement factor, α, β and γ are calibration factors, |d| is the determined distance between the user equipment and the vehicle divided by a maximum reference distance, θ is the angle made by the direction of the path of the user equipment to the straight line connecting the user equipment and the vehicle and is the value of the instantaneous speed of the user divided by a maximum reference speed.

Preferably, the movement factor o is computed based on successive measurements of the absolute amplitude of an acceleration by the array of position and movement sensors of the user equipment over a predefined time interval.

As one variant, a plurality of thresholds for the value of the user intent Int are defined in the user equipment, crossing of said thresholds triggering a modification of the frequency at which UWB signals are sent by the vehicle.

As another variant, the user equipment computes an intent to move away, denoted IntE, of a user of a vehicle, based on the user intent Int computed as above, according to the following formula:

[Math 8]

$$IntE = 1 - Int$$

An aspect of the invention also relates to a vehicle, in particular a motor vehicle, said vehicle comprising a geolocation module configured to determine the geolocation of said vehicle, a so-called “hands-free” activation system configured to implement a UWB location function to locate a user equipment such as described above, said activation system comprising an electronic control unit, at least one UWB antenna module, connected to said electronic control unit and configured to communicate via UWB with the user equipment in a region of activation around the vehicle, and at least one BLE antenna module, connected to said electronic control unit and configured to communicate via BLE in a region of coverage around the vehicle, said electronic control unit being configured to receive the geolocation of the vehicle and a value of an angle of orientation of the vehicle with respect to magnetic north, send said geolocation to the user equipment via the at least one UWB antenna module, activate the UWB location function when the computed user intent Int is greater than a first predetermined threshold or deactivate the UWB location function when the computed user intent Int is less than a second predetermined threshold, and trigger the access function when the UWB location function detects the user in the region of activation around the vehicle.

An aspect of the invention also relates to an assembly comprising a user equipment such as described above and a vehicle such as described above.

### BRIEF DESCRIPTION OF THE DRAWINGS

Further features and advantages of aspects of the invention will become more clearly apparent upon reading the following description. The latter is purely illustrative and should be read with reference to the appended drawings, in which:

FIG. 1 schematically illustrates a path of approach of a user through regions covered by the various interfaces around the vehicle according to the prior art.

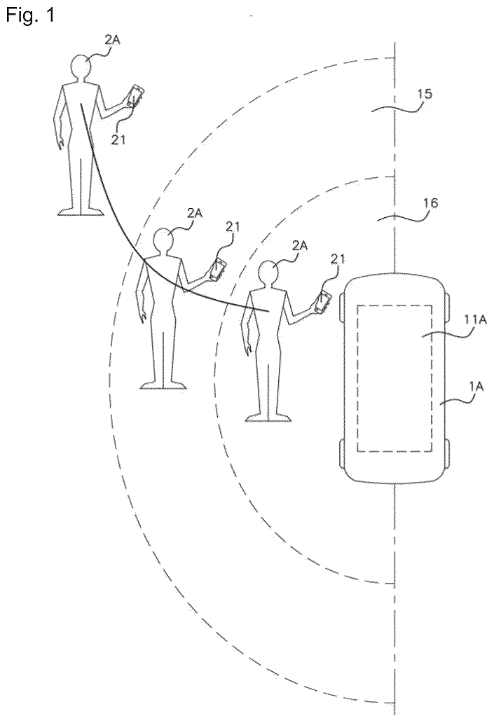

FIG. 2 schematically illustrates the configuration of the vehicle and of the user equipment according to an aspect of the invention.

FIG. 3 schematically illustrates the operation of an aspect of the invention.

FIG. 4 schematically illustrates one embodiment of the method according to an aspect of the invention.

### DETAILED DESCRIPTION OF EXEMPLARY EMBODIMENTS

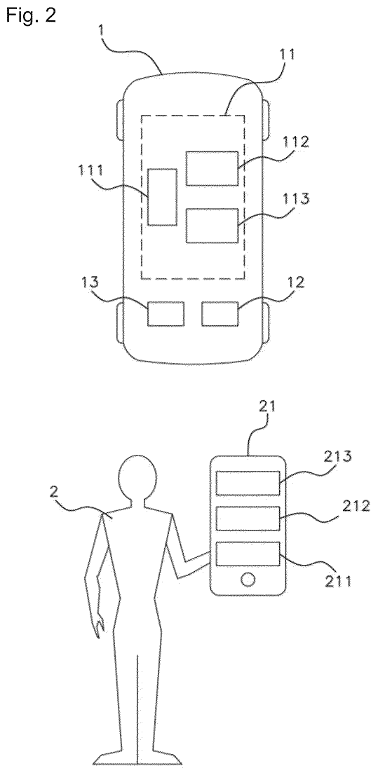

One embodiment of the vehicle 1, a function of which is activated by the method according to the invention from an equipment carried by a user, is shown in FIG. 2.

The vehicle 1 comprises an activation system 11 comprising an electronic control unit 111, a BLE antenna module 112, and a UWB antenna module 113.

The user 2 of the vehicle 1 carries on him or her a user equipment 21, preferably a smartphone.

The user equipment 21 comprises a processor 211, an array 212 of position and movement sensors, and an antenna module 213 configured to receive and transmit via BLE and UWB.

The processor 211 is configured to receive the geolocation of the vehicle 1, which is transmitted by the BLE antenna module 112.

The processor 211 is configured to determine the geolocation of the user equipment 21 by means of the array of position and movement sensors 212.

The processor 211 is configured to determine the geolocation of the user equipment 21 by means of the array of position and movement sensors 212.

The processor 211 is configured to compare the geolocation of the user equipment 21 with a history of previously recorded geolocations of the user equipment 21 in order to determine the path 22 of the user 2.

The processor 211 is configured to determine the distance of the user equipment 21 from the vehicle 1 based on the received geolocation of the vehicle 1 and on the determined geolocation of the user equipment 21.

The processor 211 is configured to compute a user intent Int.

The processor 211 is configured to send to the activation system 11, by means of the antenna module 213, a signal for activating the location function performed by means of the UWB antenna module 113 when the computed user intent Int is greater than a first predetermined threshold or deactivating the location function performed by means of the UWB antenna module 113 when the computed user intent Int is less than a second predetermined threshold.

The processor 211 is configured to determine a movement factor, denoted σ, equal to 0 if the user 2 is determined to not be moving and equal to 1 if the user 2 is determined to be moving.

The electronic control unit 111 is configured to receive data from the geolocation sensor 12 and from the sensor of magnetic orientation 13 of the vehicle 1, to exchange data with the user equipment 21 by way of the BLE antenna module 112 and UWB antenna module 113 and to activate or deactivate an access function of the vehicle 1.

In a known manner, the BLE antenna module 112 defines a region of coverage 15 in which the user equipment 21 is able to communicate via BLE with the vehicle 1.

The region of coverage 15 corresponds to the region in which the method according to an aspect of the invention is implemented.

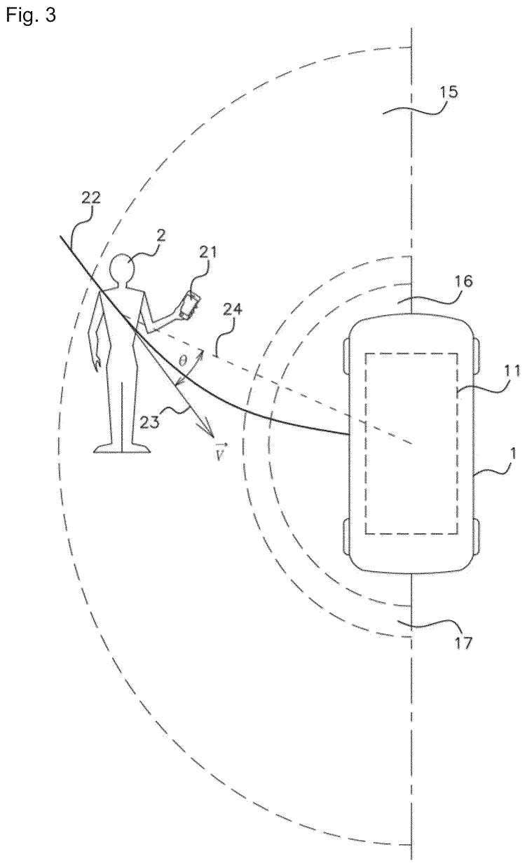

As shown in FIG. 3, the user 2, located in the region of coverage 15, and the vehicle 1 are connected by way of illustration by a fictitious straight line 24. The user 2 moves in such a way as to describe a path 22 with an instantaneous speed 23, and the angle made between the fictitious straight line 24 and the direction of the path 22 is denoted θ.

The region of activation 16 corresponds to the region into which entry of the user 2 marks activation of the access function of the vehicle 1 by the activation system 11.

The region of deactivation 17 corresponds to the region from which exit of the user 2 marks deactivation of the access function of the vehicle 1 by the activation system 11.

### Example of Implementation

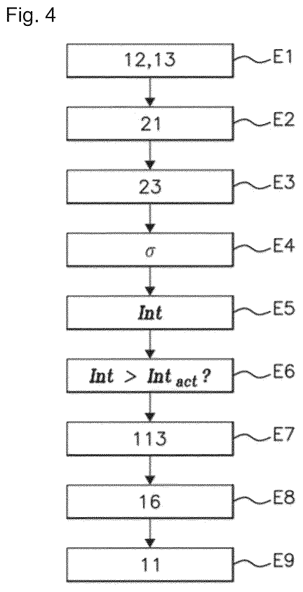

Two modes of operation are implemented by the method, which is illustrated in FIG. 4. The first mode concerns activation of an access function, the other deactivation of the access function.

### First Mode of Operation

In this mode of operation, the user 2 equipped with the user equipment 21 is located outside the region of coverage 15 and the access function of the vehicle 1 is deactivated.

When the user 2 equipped with the user equipment 21 enters the region of coverage 15, for example by approaching to a distance of less than 100 meters from the vehicle 1, the user equipment 21 and the activation system 11 of the vehicle 1 begin to communicate via a BLE interface.

In a step E1, the user equipment 21 receives from the activation system 11 the geolocation of the vehicle 1 and its orientation with respect to magnetic north, these two data items being obtained by the geolocation sensor 12 and by the sensor of magnetic orientation 13 of the vehicle 1.

In a step E2, the user equipment 21 determines its geolocation by means of the array 212 of position and movement sensors.

In a step E3, the user equipment 21 determines, by means of the array 212 of position and movement sensors, the path 22 of the user 2 in light of his or her previous movements, the instantaneous speed 23 of the user 2 and the angle made between his or her path 22 and the straight line 24 connecting the user 2 to the vehicle 1.

In a step E4, the processor 211 determines a movement factor, denoted σ, that is equal to 0 if the user 2 is determined to not be moving and equal to 1 if the user 2 is determined to be moving.

In a step E5, the processor 211 computes a user intent Int, according to the following formula:

[Math 9]

$$Int = σ [ 1 - [ ( α \cdot \vert d \vert ) ]$$

where σ is the movement factor, α is a calibration factor, and |d| is the determined distance between the user equipment 21 and the vehicle 1 divided by a maximum reference distance, for example 100 m.

Preferably, the formula used in step E5 to compute the user intent Int is:

[Math 10]

$$Int = σ [ 1 - [ ( α \cdot \vert d \vert ) + β \cdot sin θ ] ]$$

where σ is the movement factor, α and β are calibration factors, |d| is the determined distance between the user equipment 21 and the vehicle 1 divided by a maximum reference distance and θ is the angle made by the direction of the path 22 of the user equipment 21 to the straight line 24 connecting the user equipment 21 and the vehicle 1.

Also preferably, the formula used in step E5 to compute the user intent Int is:

[Math 11]

$$Int = σ [ 1 - [ ( α \cdot \vert d \vert ) + β \cdot sin θ + γ \cdot \vert V \vert \cdot cos θ ] ]$$

where σ is the movement factor, α, β and γ are calibration factors, |d| is the determined distance between the user equipment 21 and the vehicle 1 divided by a maximum reference distance, for example 100 m, θ is the angle made by the direction of the path 22 of the user equipment 21 to the straight line 24 connecting the user equipment 21 and the vehicle 1 and |V| is the value of the instantaneous speed 23 of the user 2 divided by a maximum reference speed, for example 2 m/s.

For example, the maximum reference distance is 100 m and the maximum reference speed is 2 m/s.

In a step E6, the processor 211 compares the value of the user intent Int with a predefined threshold.

If the user intent Int is greater than the predefined threshold, the user equipment 21 sends to the activation system 11 a signal for activating the location function performed by means of the UWB antenna module 113 in a step E7.

As a variant, after step E3, the user equipment 21 sends to the activation system 11 the path 22 of the user 2 in light of his or her previous movements, the instantaneous speed 23 of the user 2 and the angle made between his or her path 22 and the straight line 24 connecting the user 2 to the vehicle 1. Steps E4, E5 and E6 are then performed by the activation system 11 and, in step E7, the activation system 11 activates the location function performed by means of the UWB antenna module 113.

The UWB communication allows the activation system 11 to more accurately determine the position of the user equipment 21.

In a step E8, the activation system 11 detects whether the user equipment 21 has entered into the region of activation 16.

If the activation system 11 detects that the user equipment 21 has entered into the region of activation 16, the activation system 11 activates the access function in a step E9.

As a variant of this second embodiment, a plurality of thresholds are defined for the value of the user intent Int, defining intervals of user intent Int.

For each interval of user intent Int computed, the user equipment 21 sends a BLE signal to the activation system 11 with a view to modifying the transmission frequency of the transmitted UWB signals. Thus, the transmission frequency of UWB signals increases as the user intent Int increases.

### Second Mode of Operation

In this mode of operation, the user 2 equipped with the user equipment 21 is initially located in the region of activation 16 after having closed the doors of the vehicle 1. The access function of the vehicle 1 and the UWB location function are activated.

In this region, the user equipment 21 and the activation system 11 of the vehicle 1 communicate by means of a UWB interface.

When the user 2 equipped with the user equipment 21 exits the region of deactivation 17 and enters into the region of coverage 15, the access function of the vehicle 1 is deactivated and the method according to an aspect of the invention begins.

In a step E1, the user equipment 21 receives from the activation system 11 the geolocation of the vehicle 1 and its orientation with respect to magnetic north, these two data items being obtained by the geolocation sensor 12 and by the sensor of magnetic orientation 13 of the vehicle 1.

In a step E2, the user equipment 21 determines its geolocation.

In a step E3, the user equipment 21 determines the path 22 of the user 2 in light of his or her previous movements, the instantaneous speed 23 of the user 2 and the angle made between his or her path 22 and the straight line 24 connecting the user 2 to the vehicle 1.

In a step E4, the processor 211 determines a movement factor, denoted σ, that is equal to 0 if the user 2 is determined to not be moving and equal to 1 if the user 2 is determined to be moving.

In a step E5, the processor 211 computes a user intent Int, according to the following formula:

[Math 12]

$$Int = σ [ 1 - [ ( α \cdot \vert d \vert ) ]$$

where σ is the movement factor, α is a calibration factor, and |d| is the determined distance between the user equipment 21 and the vehicle 1 divided by a maximum reference distance, for example 100 m.

Preferably, the formula used in step E5 to compute the user intent Int is:

[Math 13]

$$Int = σ [ 1 - [ ( α \cdot \vert d \vert ) + β \cdot sin θ ] ]$$

where σ is the movement factor, α and β are calibration factors, |d| is the determined distance between the user equipment 21 and the vehicle 1 divided by a maximum reference distance and θ is the angle made by the direction of the path 22 of the user equipment 21 to the straight line 24 connecting the user equipment 21 and the vehicle 1.

Also preferably, the formula used in step E5 to compute the user intent Int is:

[Math 14]

$$Int = σ [ 1 - [ ( α \cdot \vert d \vert ) + β \cdot sin θ + γ \cdot \vert V \vert \cdot cos θ ] ]$$

where σ is the movement factor, α, β and γ are calibration factors, |d| is the determined distance between the user equipment 21 and the vehicle 1 divided by a maximum reference distance, for example 100 m, 0 is the angle made by the direction of the path 22 of the user equipment 21 to the straight line 24 connecting the user equipment 21 and the vehicle 1 and |V| is the value of the instantaneous speed 23 of the user 2 divided by a maximum reference speed, for example 2 m/s.

In a step E6, the processor 211 compares the value of the user intent Int with a predefined threshold.

If the user intent Int is less than the predefined threshold, the user equipment 21 sends to the activation system 11 a signal for deactivating the location function performed by means of the UWB antenna module 113 in a step E7.

As a variant, after step E3, the user equipment 21 sends to the activation system 11 the path 22 of the user 2 in light of his or her previous movements, the instantaneous speed 23 of the user 2 and the angle made between his or her path 22 and the straight line 24 connecting the user 2 to the vehicle 1. Steps E4, E5 and E6 are then performed by the activation system 11 and, in step E7, the activation system 11 deactivates the location function performed by means of the UWB antenna module 113.

From then on, the method proceeds as in the first embodiment with a BLE communication between the vehicle 1 and the user equipment 21. Therefore, the computation of the user intent Int continues, and if this value exceeds a second predefined threshold, the user equipment 21 sends to the activation system 11 a signal for activating the UWB antenna module 113, followed by activation of the access function when the user 2 reaches the region of activation 16.

As a variant of this second embodiment, a plurality of thresholds are defined for the value of the user intent Int, defining intervals of user intent.

For each interval of user intent Int computed, the user equipment 21 sends a BLE signal to the activation system 11 with a view to modifying the transmission frequency of the transmitted UWB signals. Thus, the transmission frequency of UWB signals decreases as the user intent Int decreases.

1. A method for activating at least one function of a vehicle from an equipment carried by a user of said vehicle, said user equipment comprising a processor, an array of position and movement sensors and an antenna module configured to communicate via Ultra Wide Band, abbreviated UWB, and Bluetooth® Low Energy, abbreviated BLE, with the vehicle, said vehicle comprising a so-called “hands-free” activation system configured to implement a UWB location function, said activation system comprising an electronic control unit, at least one UWB antenna module, connected to said electronic control unit and configured to communicate via UWB with the user equipment in a region of activation around the vehicle, and at least one BLE antenna module, connected to said electronic control unit and configured to communicate via BLE in a region of coverage around the vehicle, said electronic control unit being configured to receive the geolocation of the vehicle and a value of an angle of orientation of the vehicle with respect to magnetic north, said method being triggered by detection of presence of the user equipment in the region of coverage around the vehicle and comprising the steps, implemented by the user equipment, of:
receiving, via the BLE antenna module, the geolocation of the vehicle sent by said vehicle,
determining, via the array of position and movement sensors, the geolocation of the user equipment,
comparing, by the processor, the determined geolocation of the user equipment with a history of previously recorded geolocations of the user equipment in order to determine the path of the user,
determining, by the processor, a movement factor, denoted σ, equal to 0 if the user is determined to not be moving and equal to 1 if the user is determined to be moving,
determining, by the processor, the distance of the user equipment from the vehicle based on the received geolocation of the vehicle and on the determined geolocation of the user equipment,
the user equipment being configured to determine, based on successive positions of the user and on the angle θ made by the direction of the path of the user equipment to the straight line connecting the user equipment and the vehicle, through computation by the processor, a user intent Int, according to the following formula:
[Math 15]
$$Int = σ [ 1 - [ ( α \cdot \vert d \vert ) + β \cdot sin θ ] ]$$
where σ is the movement factor, α and β are calibration factors, |d| is the determined distance between the user equipment and the vehicle divided by a maximum reference distance and θ is the angle made by the direction of the path of the user equipment to the straight line connecting the user equipment and the vehicle,
sending, via the antenna module, to the activation system of the vehicle, a signal for activating the UWB location function when the computed user intent Int is greater than a first predetermined threshold or deactivating the location function performed by the UWB antenna module when the computed user intent Int is less than a second predetermined threshold.

2. The method as claimed in claim 1, wherein the user equipment is configured to determine, based on successive positions of the user, a value of an instantaneous speed of the user and to compute the user intent Int according to the formula:
[Math 16]
$$Int = σ [ 1 - [ ( α \cdot \vert d \vert ) + β \cdot sin θ + γ \cdot \vert V \vert \cdot cos θ ] ]$$
where σ is the movement factor, α, β and γ are calibration factors, |d| is the determined distance between the user equipment and the vehicle divided by a maximum reference distance, θ is the angle made by the direction of the path of the user equipment to the straight line connecting the user equipment and the vehicle and |V| is the value of the instantaneous speed of the user divided by a maximum reference speed.

3. The method as claimed in either of claim 1, wherein the movement factor o is computed based on successive measurements of the absolute amplitude of an acceleration by the array of position and movement sensors over a predefined time interval.

4. The method as claimed in claim 1, wherein a plurality of thresholds are defined for the value of the user intent Int, crossing of said thresholds triggering a modification of the frequency at which UWB signals are sent by the vehicle.

5. A method for determining an intent to move away, denoted IntE, of a user of a vehicle, computed based on the user intent Int computed according to claim 1, according to the following formula:
[Math 17]
$$IntE = 1 - Int$$
